(19) United States
(12) Patent Application Publication
(10) Pub. No.: US 2025/0278042 A1
(43) Pub. Date: Sep. 4, 2025

(54) FIXING DEVICE OF IMAGE FORMING DEVICE

(71) Applicant: SHARP KABUSHIKI KAISHA, Osaka (JP)

(72) Inventor: Shinji YAMANA, Osaka (JP)

(21) Appl. No.: 19/063,543

(22) Filed: Feb. 26, 2025

(30) Foreign Application Priority Data
Mar. 1, 2024 (JP) 2024-031644

(51) Int. Cl. G03G 15/20

(52) U.S. Cl. CPC G03G 15/205

(57) ABSTRACT

A fixing device includes a contact thermistor that comes into contact with a fixing belt and a thermopile that does not come into contact with the fixing belt, and a control microcomputer that compares a detection result of the contact thermistor with a detection result of the thermopile in initial operation under a predetermined condition, and corrects the detection result of the thermopile. The control microcomputer initializes a correction value to be used for correction when the correction value exceeds a maximum value determined in advance.

### CROSS-REFERENCE TO RELATED APPLICATION

The present application claims priority from Japanese Application JP2024-031644, the content to which is hereby incorporated by reference into this application.

### BACKGROUND OF THE INVENTION

### 1. Field of the Invention

The disclosure relates to a fixing device of an image forming device.

### 2. Description of the Related Art

In the related art, there has been known a fixing device of an image forming device that obtains a correction value based on relationship information derived in advance and representing a relationship between a change rate per unit time of a temperature detected by a non-contact temperature detector during warm-up and a correction value for a temperature detected by a contact temperature detector provided in a fixing unit, corrects the temperature detected by the non-contact temperature detector using the correction value, and controls operation of a heater.

### SUMMARY OF THE INVENTION

The known image forming device in which the temperature detected by the non-contact temperature detector is corrected during warm-up of the fixing device to control the operation of the heater is configured as follows. On the other hand, in such a fixing device, when a trouble occurs due to a sensor temperature abnormality, the correction value reaches the maximum value, and the sensor is replaced to eliminate the abnormality. However, the correction value that has reached the maximum value is used until the timing of the next correction value measurement, and there is an issue that there is a possibility of a fixing failure, hot offset, or the like due to a deviation in the detected temperature.

The disclosure has been made to address the above-described issue, and an object of the disclosure is to provide a fixing device of an image forming device capable of reducing the possibility of temperature deviation after sensor replacement.

According to an aspect of the disclosure, there is provided a fixing device of an image forming device, including: a contact-type temperature detector that comes into contact with a fixing belt, and a non-contact-type temperature detector that does not come into contact with the fixing belt; and a controller that compares a detection result of the contact-type temperature detector with a detection result of the non-contact-type temperature detector in initial operation under a predetermined condition, and corrects the detection result of the non-contact-type temperature detector, in which the controller initializes a correction value to be used for correction when the correction value to be used for the correction exceeds a maximum value determined in advance.

Preferably, the controller includes a storage that stores the correction value to be used for the correction; and the controller compares the correction value acquired in the initial operation with the correction value to be used for the correction, uses the correction value having a larger absolute value for the correction, and overwrites the correction value stored in the storage.

More preferably, the controller is connected to a server; and when initializing the correction value to be used for the correction, an external control center is notified of a failure of the non-contact-type temperature detector via the server.

The initial operation may be performed a plurality of times; and the controller may compare a correction value acquired in previous initial operation with a correction value acquired in current initial operation, notify an external control center of a failure of the non-contact temperature detector via the server when there is a difference of a predetermined amount, and initialize the correction value stored in the storage.

In initializing the correction value stored in the storage, the correction value acquired in the initial operation may be set as the correction value.

According to an aspect of the disclosure, the correction value to be used for the correction is initialized when the correction value to be used for the correction exceeds a maximum value determined in advance, and therefore it is possible to provide a fixing device of an image forming device capable of reducing the possibility of temperature deviation after sensor replacement.

The above-described objects, other objects, features, and advantages of the disclosure will be further obvious from the detailed description of examples given below with reference to the drawings.

### BRIEF DESCRIPTION OF THE DRAWINGS

FIG. 1 illustrates a fixing device of an image forming device according to an embodiment of the disclosure.

FIG. 2 is a flowchart illustrating operation of the fixing device.

### DETAILED DESCRIPTION OF THE INVENTION

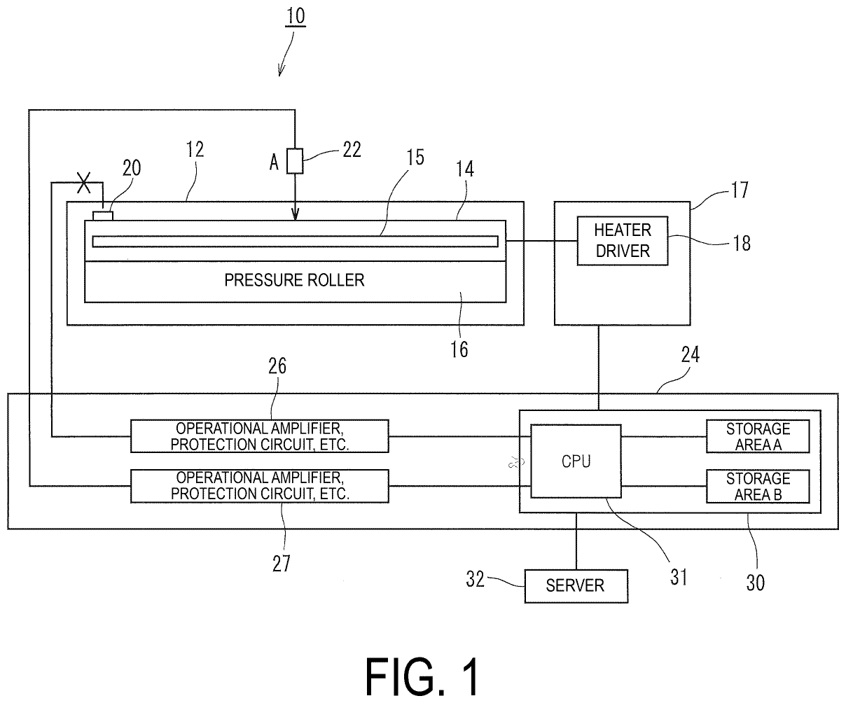

An embodiment according to the disclosure will be described in detail below with reference to the drawings. FIG. 1 illustrates a fixing device of an image forming device according to an embodiment of the disclosure. With reference to FIG. 1, a fixing device 10 of an image forming device includes a fixing unit 12. The fixing unit 12 includes a fixing belt 14 and a pressure roller 16. The fixing belt 14 includes therein a heater lamp 15 that heats the fixing belt 14.

The heater lamp 15 is heated by a heater driver 18 included in a heater driver unit 17. The fixing belt 14 is provided with a contact thermistor 20 (contact-type temperature detector, indicated by X in FIG. 1) that comes into contact with the fixing belt 14 and detects the temperature of the fixing belt 14, and a thermopile 22 (non-contact-type temperature detector, indicated by A in FIG. 1) that is provided outside the fixing unit 12 and detects the temperature of the fixing unit 12.

### First Embodiment

The contact thermistor 20 and the thermopile 22 are connected to at least one control microcomputer (controller) 30 via an operational amplifier and a protection circuit 26 for the contact thermistor and an operational amplifier and a protection circuit 27 for the thermopile, which are included in a power control unit 24. The control microcomputer 30 includes a CPU 31, and a storage area A and a storage area B that store predetermined correction values. The control microcomputer 30 is connected to the heater driver unit 17.

The control microcomputer 30 is connected to a control center (not illustrated) via a server 32.

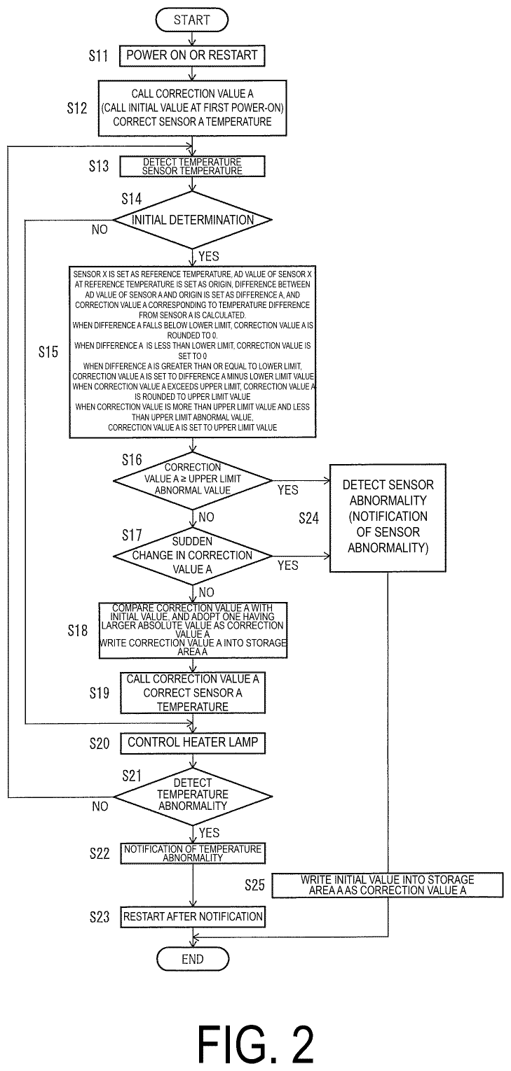

Next, operation of the control microcomputer 30 will be described. FIG. 2 is a flowchart illustrating operation of the control microcomputer 30. With reference to FIG. 2, when the power of the image forming device is turned on or the image forming device is restarted, the following processing is started (step S11; hereinafter, the word “step” may be omitted). First, a correction value A to be used to correct the detection result of the thermopile 22 (indicated as “sensor A” in FIG. 2) based on the detection result of the contact thermistor 20 is called (an initial value is called when the power is turned on for the first time), and the temperature of the thermopile 22 is corrected (step S12).

Here, an example of the initial value will be described. The initial value is a correction value corresponding to the circuit offset measured during the production process, and is written in the storage area B. This initial value is not overwritten. The upper limit value of the initial value is an AD value of 10 counts, for example. If the upper limit value is exceeded, a substrate check process of the production process (not illustrated) is performed.

Next, the temperature of the temperature sensor (thermopile 22) is detected (S13), and the initial operation is determined (S14). Here, the determination of the initial operation is to determine whether it is before the heater lamp 15 is turned on after the power is turned on and both the contact thermistor 20 and the thermopile 22 are 30° C. or less.

If the initial determination is OK (YES) in S14, the temperature of the contact thermistor 20 (indicated as “sensor X” in FIG. 2) is set as a reference temperature, the AD value of the contact thermistor 20 at the reference temperature is set as an origin, the difference between the AD value of the thermopile 22 and the origin is set as a difference A, and a correction value A corresponding to the temperature difference from the thermopile 22 is calculated (S15).

Here, an upper limit value and a lower limit value of the difference A have been determined in advance, and the correction value is rounded to 0 when the difference A falls below the lower limit value. That is, the correction value is set to 0 when the difference A is less than the lower limit value, and the correction value A is set to the difference A minus the lower limit value when the difference A is greater than or equal to the lower limit value.

On the other hand, the correction value A is rounded to the upper limit value when the difference A is more than the upper limit value.

That is, the correction value A is set to the upper limit value when the upper limit value is less than the difference A.

Here, a calculation example of the correction value A will be described. It is assumed that the AD value of the contact thermistor 20 at the reference temperature (the temperature of the contact thermistor 20 is 20° C., for example) is 400 (origin). The lower limit value is set to 2, that is, the AD value of the thermopile 22 corresponding to the temperature error of the contact thermistor 20. In addition, the upper limit value is set to an AD value of 8, that is, an offset+a including the periphery of the operational amplifier.

As an example, if the AD value of the thermopile 22 is 409, the difference A is the AD value of the thermopile 22 minus the origin, and thus is 409−400=9.

Since the lower limit value is 2 and the upper limit value is 8, the correction value A (difference A-lower limit value) is 9−2=7.

As another example, if the AD value of the thermopile 22 is 412, for example, the difference A is 412−400=12.

Since the lower limit value is 2 and the upper limit value is 8, the correction value A is 12−2=10. In this way, when the correction value is more than the upper limit value, it is considered that the correction value involves a detection error, and the correction value A is rounded to the upper limit value so that the correction value A does not include the detection error. Thus, in this case, the correction value A is 8.

Next, the process proceeds from S15 to S16, and it is determined whether the correction value A is greater than or equal to an upper limit abnormal value. Here, the upper limit abnormal value is an AD value of 20, for example, so as to correspond to the detected temperature assumed at the time of failure of the thermopile 22, for example. If the correction value A is greater than or equal to the upper limit abnormal value (YES in S16), it is detected that the sensor (thermopile 22) is abnormal, and the control center (not illustrated) is notified of the sensor abnormality via the server 32 (S24). At this time, the sensor (thermopile 22) is replaced.

If the correction value A is not greater than or equal to the upper limit abnormal value (NO in S16), it is determined whether the correction value A has changed suddenly (S17). When it is determined that the correction value A has changed suddenly (YES in S17), a sensor abnormality is detected as in the case of S16, and the control center (not illustrated) is notified of the sensor abnormality via the server 32 illustrated in FIG. 1 (S24).

Here, a sudden change in the correction value A will be described. Here, the correction value acquired in the initial operation and stored in the storage region B is compared with the previous correction value (the correction value before overwriting stored in the storage region A), and it is determined that the correction value A has changed suddenly when the difference is an AD value of 5 or more, for example.

Not only the upper limit abnormality but also the sudden change of the correction value is captured in order not to overlook the abnormality of the sensor (thermopile 22).

The sudden change in the correction value may occur at the initial stage of the abnormality of the sensor (thermopile 22), and the sudden change may occur several times before the occurrence of the abnormality. Thus, the sensor abnormality may be detected when the sudden change in the correction value is detected three times.

### Second Embodiment

When it is determined in S17 that the correction value A has not changed suddenly (NO in S17), the correction value A is compared with the initial value stored in the storage area B, and the correction value having the larger absolute value is adopted as the correction value A to overwrite the storage area A with the correction value A (S18).

Next, the correction value A is called, and the temperature of the thermopile (sensor A in FIG. 2) 22 is corrected (S19). Thereafter, the heater lamp 15 is controlled (S20).

On the other hand, when it is determined in S14 that the temperature is not the temperature for the initial determination (NO in S14), the heater lamp 15 is controlled (S20).

Next, any temperature abnormality is detected (S21). If there is any temperature abnormality (YES in S21), a notification of the temperature abnormality is made (S22). After the notification is handled, restart is performed (S23), and the process is ended.

Here, an example of detection of the temperature abnormality will be described. The detection of the temperature abnormality is not necessarily regarded as a sensor abnormality of the thermopile 22. Thus, the initial value is not set to the correction value A only by the notification of the temperature abnormality. This temperature abnormality corresponds to burnout of a heater lamp or the like, for example.

Next, the process in S24 in the case of YES in S16 (correction value A≥upper limit abnormal value) will be described. When a sensor abnormality is detected in S24, the initial value stored in the storage area B is written into the storage area A as the correction value A (S25), and the process is ended.

As described above, in the disclosure, when the correction value to be used for correction exceeds a maximum value (upper limit abnormal value) determined in advance (YES in S16, S24 to S25), the control microcomputer 30 initializes the correction value by replacing the sensor (thermopile 22). In this way, by returning the correction value to the initial value after the trouble having occurred due to the sensor temperature abnormality is eliminated, it is possible to reduce the possibility of temperature deviation after sensor replacement.

If there is no temperature abnormality in S21 (NO in S21), the process proceeds to detection of the temperature of the thermopile 22 (S13).

Although the heater lamp is indicated as one element in the above embodiment, the heater lamp includes a main lamp and a sub-lamp, and the thermopile is provided at positions corresponding to the main lamp and the sub-lamp.

Further, the upper and lower limit abnormal values of the correction value for correcting the thermopiles corresponding to the main lamp and the sub-lamp may be individually provided.

The disclosure may be embodied in other various forms without departing from the spirit or essential characteristics thereof. Thus, the above embodiments are merely examples and should not be interpreted as limiting. All modifications and changes equivalent in scope with the claims of the disclosure are included in the scope of the disclosure.

According to the disclosure, the correction value is initialized when the correction value exceeds a maximum value determined in advance, and therefore it is possible to provide a fixing device capable of reducing the possibility of temperature deviation after sensor replacement. Therefore, the fixing device is useful as a fixing device provided in an image forming device.

What is claimed is:

1. A fixing device of an image forming device, comprising:
a contact-type temperature detector that comes into contact with a fixing belt, and a non-contact-type temperature detector that does not come into contact with the fixing belt; and
a controller that compares a detection result of the contact-type temperature detector with a detection result of the non-contact-type temperature detector in initial operation under a predetermined condition, and corrects the detection result of the non-contact-type temperature detector,
wherein the controller initializes a correction value to be used for correction when the correction value to be used for the correction exceeds a maximum value determined in advance.

2. The fixing device of an image forming device according to claim 1,
wherein the controller includes a storage that stores the correction value to be used for the correction, and
the controller compares the correction value acquired in the initial operation with the correction value to be used for the correction, uses the correction value having a larger absolute value for the correction, and overwrites the correction value to be used for the correction stored in the storage.

3. The fixing device of an image forming device according to claim 1,
wherein the controller is connected to a server, and
when initializing the correction value to be used for the correction, an external control center is notified of a failure of the non-contact-type temperature detector via the server.

4. The fixing device of an image forming device according to claim 3,
wherein the initial operation is performed a plurality of times, and
the controller compares a correction value acquired in previous initial operation with a correction value acquired in current initial operation, notifies an external control center of a failure of the non-contact temperature detector via the server when there is a difference of a predetermined amount, and initializes the correction value to be used for the correction stored in the storage.

5. The fixing device of an image forming device according to claim 2,
wherein in initializing the correction value to be used for the correction stored in the storage, the correction value acquired in the initial operation is set as the correction value.
